(19) United States
(12) Patent Application Publication
(10) Pub. No.: US 2008/0243575 A1
(43) Pub. Date: Oct. 2, 2008

(54) System and Method for Dynamically Allocating Human Resources to a Project Plan

(76) Inventor: Keith Weinberger, San Antonio, TX (US)

Correspondence Address: PILLSBURY WINTHROP SHAW PITTMAN, LLP, P.O. BOX 10500, MCLEAN, VA, 22102, US

(21) Appl. No.: 11/694,255

(22) Filed: Mar. 30, 2007

(51) Int. Cl. G06F 9/46

(52) U.S. Cl. 705/8

(57) ABSTRACT

A system and method for dynamically allocating human resources to a project plan is provided. Audit data associated with legacy planning processes may be analyzed in order to estimate an amount of work effort, a cost, or other information associated with various resources (e.g., the resource may be assigned a relative value based on skills maturity, experience, overall repertoire, or other factors). As such, a more accurate assessment of a given project plan may be created, thereby providing various advantages, such as minimizing risks, improving confidence in estimates or proposals, improving return on investment calculations, maximizing profitability per project, or effectively identifying which projects should be allocated to skilled workers, entry level or lower skilled workers, or otherwise.

### FIELD OF THE INVENTION

The invention relates to a system and method for dynamically allocating human resources to a project plan.

### BACKGROUND OF THE INVENTION

When enterprises or other organizations undertake a particular work effort, initial efforts may often focus on developing a plan for implementing the work effort, identifying human resources (e.g., personnel) for implementing the plan, or estimating costs, among various other things. Developing detailed plans allows professional service organizations to effectively allocate human resources to a project, and can provide clients with meaningful information to evaluate or compare service proposals. For example, enterprises may utilize a project plan to schedule timelines for completing various tasks, organize or allocate human resources to complete the tasks, estimate costs associated with the tasks, assess risk associated with a project, or identify projects best suited for training or other purposes, among other things. Further, clients may rely upon project plans to compare proposals from different vendors, perform cost/benefit or return on investment analyses, or determine budgets, among other things.

Accordingly, professional service providers and professional service clients place a high value on detailed and accurate proposals that assess how a project will be implemented, and what the costs of the project will be, among other things. Using existing planning systems, however, allocating or otherwise scheduling human resources within a project plan tends to be defined as a series of generic resource classes. More particularly, existing systems do not adequately distinguish or otherwise account for various skill levels or qualifications associated with resources assigned to various tasks, stages, phases, or other aspects of a project. As a result, project plans developed using existing systems may fail to accurately depict the work efforts, cost estimates, scheduling timelines, or other factors associated with the project.

Furthermore, many professional service providers may often provide the same or similar services to many different clients. As such, a higher degree of transparency may enable clients to maximize investment returns, or pay premiums for variations in service (e.g., a higher amount may be paid for accelerated delivery, or for more experienced human resources, among other things). Moreover, the professional service providers can leverage their knowledge to implement best practices, train employees, or effectively allocate resources to various tasks, among other things. However, existing systems or applications for planning projects, estimating human resource costs, or performing similar tasks often fall short in efforts to effectively utilize legacy planning processes.

Existing systems suffer from these and other problems.

### SUMMARY OF THE INVENTION

According to various aspects of the invention, a system and method for dynamically allocating human resources to a project plan may address these and other drawbacks of existing systems. For example, among other things, the invention may analyze audit data associated with legacy planning processes to estimate an amount of work effort or a cost associated with a specific human resource type (e.g., a human resource type may have a relative value based on skills maturity, experience, overall repertoire, or other factors). As such, the estimated work efforts, costs, or other estimated data may reflect a more accurate assessment of a given project plan, thereby providing various advantages, such as minimizing risks, improving confidence in estimates or proposals, improving return on investment calculations, maximizing profitability per project, or effectively identifying which projects should be allocated to skilled workers, entry level or lower skilled workers, or otherwise, among various other advantages.

According to various aspects of the invention, a project plan framework may be generated based upon an analysis of audit data, event data, or various other kinds of data associated with a services enterprise or other suitable organization. For example, a service-oriented enterprise may provide a large volume of services to many different clients, such that the enterprise may have a significant amount of auditable data, wherein the audit data may be collected and analyzed in various ways in order to the generate project plan framework. For example, the generated project plan framework may collect, analyze, or otherwise audit enterprise data to identify tasks, human resource allocations, costs, work efforts, or other information to associate with a given project, proposal, or other application of human resources.

According to various aspects of the invention, the generated project plan framework may include various tasks, which may be organized or classified according to a type, a phase, a service, or other criteria. Further, each task may be assigned or otherwise associated with various human resource types (e.g., project managers, architects, consultants, etc.) responsible for implementing the tasks. Each human resource type may possess a unique skill set, where each resource type allocated to a task may expend a determined amount of work effort on the task (e.g., a time as measured in work days, work hours, work minutes, or otherwise), and further at a given cost (e.g., based on a function of the work effort and a billing rate, or other suitable cost measure). Accordingly, the generated framework may include various services making up a project or proposal, as well as phases and tasks to be implemented in furtherance of the services. Furthermore, the generated framework may include accurate, reliable and itemized estimates of costs, work efforts, or other criteria for each task, based on human resource types assigned to the tasks, thereby giving a more accurate assessment of a given project.

According to various aspects of the invention, the generated framework may be customized in various ways. For example, services may be added, removed, modified, or otherwise customized for any given implementation. Further, tasks may be added, removed, modified, or otherwise customized as needed for the particular implementation. For example, an enterprise that provides services to a client on many different occasions may not necessarily need to implement tasks for introducing team members, assessing the client's existing systems, or otherwise. It will be apparent, however, that task customization may be appropriate or suitable for a given implementation for various reasons. In addition, the generated framework may be customized by dynamically allocating human resources to the tasks in a project. For example, a task may be allocated to highly skilled workers for more important or higher value projects or tasks, whereas lower skilled workers may be allocated to simple tasks, for training purposes, or for other reasons. It will be apparent, however, that human resources may be assigned to tasks for various different reasons, without limitation.

According to various aspects of the invention, the generated framework may be updated in response to the dynamic customization of tasks, human resource allocations, or other criteria. For example, work efforts, costs, timelines, or other components of the framework may be updated in response to dynamic resource allocation. For instance, a highly skilled resource type (e.g., a senior architect) may be able to perform a given task in less time, or by expending less work effort, relative to a resource type having a lower skill level (e.g., an associate architect). Further, various resource types may be associated with different cost measures (e.g., more skilled resources may have higher billing rates), such that the dynamic allocation of resources may impact costs associated with a task, service, project, or otherwise.

Accordingly, a project plan generated using the systems and methods of the invention described herein may provide various advantages, and may be used as part of any suitable application of human resource costs. For example, the invention may be used to schedule or otherwise plan internal projects (e.g., deploying new systems), training projects, third-party services, or any other application of human resources. As such, the invention may have broad applicability to enable enterprises, clients, or other organizations to assess or otherwise plan the components of a project, including tasks, personnel, work efforts, costs, or other factors associated therewith. Thus, the invention may be used to facilitate reliable risk assessments, improve confidence in estimates or proposals, improve return on investment calculations, maximize profitability per project, or effectively identify which projects should be allocated to skilled workers, entry level workers, or lower skilled workers, among other things.

Other objects and advantages of the invention will be apparent to those skilled in the art based on the following drawings and detailed description.

### BRIEF DESCRIPTION OF THE DRAWINGS

FIG. 1 illustrates an exemplary system for dynamically allocating human resources to a project plan according to various aspects of the invention.

FIG. 2 illustrates an exemplary project plan framework according to various aspects of the invention.

FIG. 3 illustrates an exemplary method for dynamically allocating human resources to a project plan framework according to various aspects of the invention.

### DETAILED DESCRIPTION

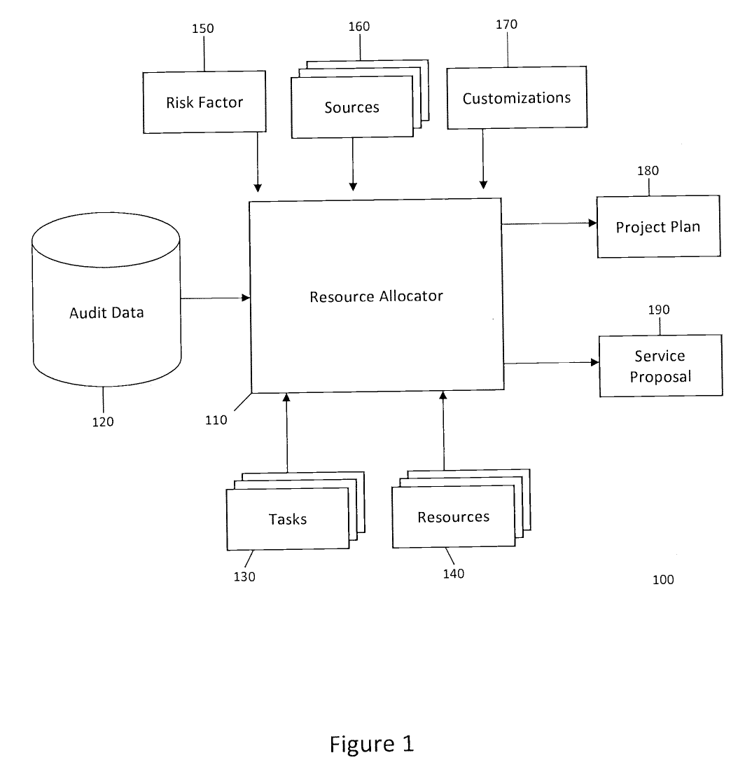

Referring to FIG. 1, an exemplary system 100 for dynamically allocating human resources to a project plan is illustrated according to various aspects of the invention. System 100 may include a resource allocator 110, which may receive data from various sources. For example, the data sources may include audit data stored in a data repository 120 or other suitable storage medium, which may provide data relating to one or more tasks 130, one or more human resources 140, one or more sources 160 (e.g., agents or other data sources), in addition to a user-specified risk factor 150 or other customizations 170. Subsequently, resource allocator 110 may centralize, normalize, standardize, or otherwise analyze the received data (e.g., by data mining or performing other suitable operations on the received data) in order to generate a project plan 180, a service proposal 190, or any other suitable output that may include or apply estimates of human resource usage.

System 100 may analyze data from various sources to generate a configurable project plan framework, where human resources may be dynamically allocated to the framework. For instance, when a service provider (e.g., a professional services enterprise) delivers a proposal, project, or other suitable service for a client, the service provider may maintain various records, event data, or other suitable information for auditing. The audit data may be stored in any suitable data repository (e.g., repository 120), and may include information such as timelines or delivery schedules, task lists, costs, risk factors, third-party requirements, or levels of integration, among other things. Accordingly, resource allocator 110 may centralize, normalize, or otherwise analyze the audit data, along with any other suitable data, to generate project plan 180 or service proposal 190, among other things. Further, because project plan 180 or service proposal 190 may be based upon actual services previously provided by an enterprise or other suitable organization, the generated framework may accurately assess costs, timelines, or other factors of a given service.

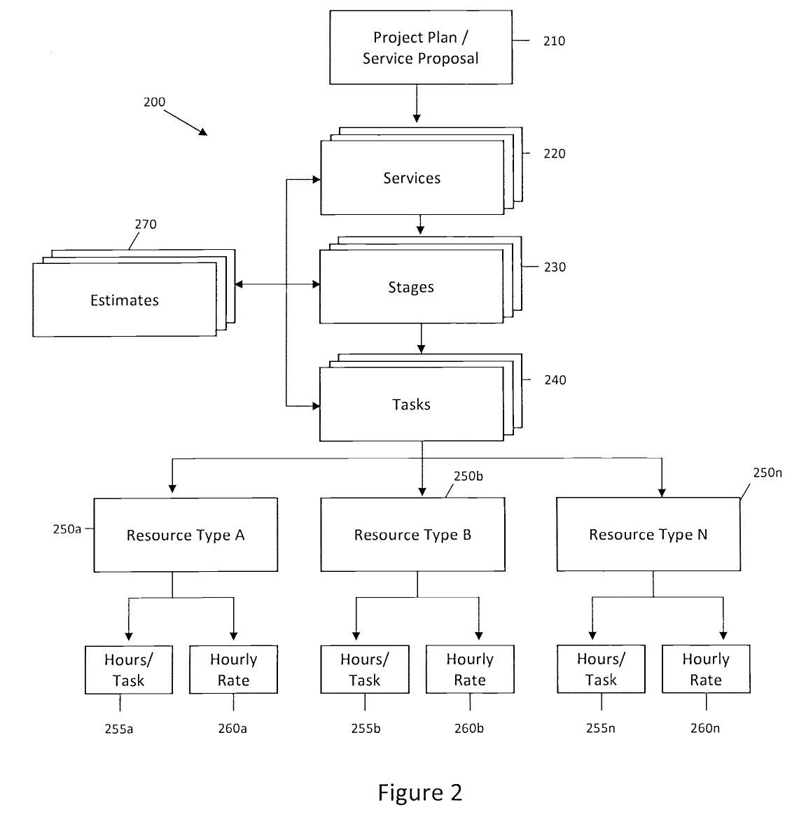

For example, referring to FIG. 2, an exemplary project plan framework 200 is illustrated according to various aspects of the invention. Framework 200 may be based upon an analysis of audit data, event data, or various other kinds of data associated with a services enterprise or other suitable organization. The data may be collected and analyzed in various ways in order to generate project plan framework 200. The audit data, event data, or other suitable data may be associated with project plans, proposals, services, or any other suitable deliveries 210 previously provided by an enterprise or other suitable organization. For example, professional services enterprises may often provide substantially similar services 220 for many different clients, where each provision of services may involve similar tasks, resource allocations, costs, work efforts, or other information. Thus, service-oriented organizations may have substantial amounts of auditable data, which may be incorporated into framework 200 to provide accurate assessments of work efforts 255a-n, estimates 270 (e.g., cost, scheduling, or other estimates), or other information associated with various project tasks 240, on a per human resource type 250a-n basis.

For example, human resource types 250a-n associated with an enterprise or other organization may include senior project managers, project managers, principal architects, senior architects, associate architects, principal consultants, senior consultants, consultants, or associate consultants, among various others. In other words, an enterprise or other organization may classify available personnel as various resource types 250a-n, where each resource type 250a-n may possess a unique skill set, experience, or other characteristic. Based on these and other characteristics, the enterprise or other organization may associate human resource types 250a-n with hourly rates, or other cost measures 260a-n. Further, due to varying levels of skill and expertise, audited data may be used to identify an amount of work effort 255a-n (e.g., an estimated number of hours) for a resource type 250a-n to perform any given task 240 (e.g., a senior project manager may perform a given project management task in less time than an assistant or associate project manager).

Accordingly, framework 200 may include accurate, reliable and itemized cost estimates 270, work effort estimates 255a-n, or other estimates, giving a more accurate assessment of a given project plan 210. Furthermore, clients may request substitution of human resource types 250a-n for various reasons. For example, a client may request, or an enterprise may assign, a more skilled human resource type 250 to a high risk deployment, to a service coming in under budget, to speed up a schedule or delivery timeline, or otherwise. Similarly, a less skilled human resource type 250 may be requested or assigned to cut costs, satisfy training objectives, or for other reasons. Thus, framework 200 may provide various advantages, such as facilitating reliable risk assessments, improving confidence in estimates or proposals, improving return on investment calculations, maximizing profitability per project, or effectively identifying which projects should be allocated to skilled workers, entry level or lower skilled workers, or otherwise.

Still referring to FIG. 2, framework 200 may be used to easily create a project plan or other service proposal 210. Project plan/service proposal 210 may include itemized entries for various services 220 to be provided, as well as various detailed project stages 230 (e.g., a delivery timeline). Each stage 230 of project 210 may further include an itemized group of tasks 240, such that stages 230 of proposal 210 may clearly set forth a schedule or timeline, while also setting forth various benchmarks, checkpoints, or other milestones. Further, each stage 230 may include configurable lists of tasks 240 (e.g., tasks may be added or removed, and tasks may be further organized or classified in various ways). Moreover, resource types 250a-n may be dynamically assigned to tasks, such that work efforts 255a-n, billing rates 260a-n, or other criteria may be customized for any given project, client, or otherwise. Eligibility to assign human resource types 250a-n to tasks may further be restricted to ensure that an appropriate human resource type 250 has been assigned to each of the tasks (e.g., project management tasks may be restricted to senior project managers, associate project managers, or otherwise, based on a resource type 250 having an appropriate skill set).

In an illustrative example, an information technology project plan 210 may be itemized as having stages 230 for setting up or initiating a project, defining and designing a solution architecture, implementing the solution in a development environment, integrating and configuring the solution, testing, installing backup systems, documenting configurations, training or transferring knowledge, converting live systems, handing off or closing the project, or any other suitable stage (e.g., optimizing, customizing, maintaining, or otherwise delivering the project). Furthermore, each stage may include a configurable list of tasks 240 for implementing a project 210, where each task 240 may be associated with one or more human resource types 250a-n. The list of tasks 240 may be configurable, for example, by having a graphical user interface or other suitable application (e.g., a spreadsheet application having various scripts or other logic embedded therein) for enabling a user to select or deselect task groups. For example, task groups may be selected or deselected according to classifications such as high availability tasks, proof of concept tasks, product implementation tasks, project management tasks, project-specific tasks, or others.

Within such task groups may be an itemized list of individual tasks 240, which may further be customizable (e.g., custom tasks may be added for a given project, or removed from the project, depending on unique needs of a particular project). For instance, a stage 230 for setting up or initiating a project 210 may include a group of project management tasks, which may include individual tasks 240 (e.g., creating and approving a project management plan, creating and approving a project schedule, scheduling start dates or physical logistics, conducting conference calls to introduce project team members, validating hardware, software, security, passwords, or other prerequisites, or presenting a client solution to an internal review team, among others). In various instances, an enterprise may have an ongoing relationship with a client, which may render various tasks unnecessary (e.g., conducting conference calls, validating requirements, etc.).

It will be apparent, therefore, that project plans or service proposals 210 based upon framework 200 may provide valuable service-oriented estimates, at varying levels of granularity. Any given project plan 210 may include a detailed schedule of project stages 230 outlining a services 220 to be provided, and each stage 230 may include various itemized tasks 240, which may be organized or analyzed in various ways. Further, each task 240 may be carried out by one or more human resource types 250a-n, where dynamic assignment of resource types 250a-n to tasks 240 may enable customization of cost estimates 270, work efforts 255a-n, or otherwise, as well as enabling benchmarks and other scheduling milestones to be closely monitored, among other advantages.

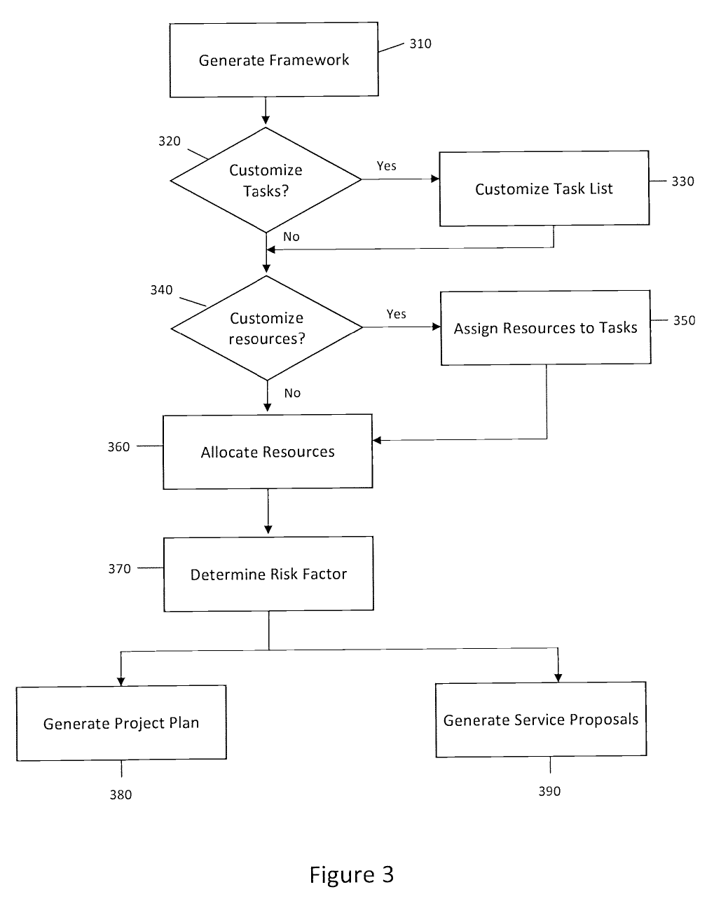

Referring to FIG. 3, an exemplary method 300 for dynamically allocating human resources to a project plan framework is illustrated according to various aspects of the invention. The project plan framework may be generated in an operation 310, where the generated framework may be based upon audit data, event data, or other data associated with a services enterprise or other suitable organization. For example, the framework generated in operation 310 may include a set of tasks for a project, which may be organized according to project stages, services, assigned resource types, or other criteria. Further, each task may be associated with or assigned to one or more human resource types, and each of the resource types may be associated with a work effort and/or a cost estimate for completing the task. The set of tasks, assigned resource types, work efforts, cost estimates, or other criteria may be dynamically customizable, such that operation 310 may include generating a dynamically configurable project plan framework. As such, the generated framework may be used for creating detailed project plans or service proposals, and further for customizing tasks, timelines, costs, skill levels for allocated resource types, or other suitable applications.

The tasks included in the framework generated in operation 310 may be customized in an operation 320. For instance, a user may customize individual tasks (e.g., by including or excluding certain tasks), task groups (e.g., by including or excluding certain groups of tasks), project stages, or various other aspects of the generated framework. Thus, when a user elects to customize tasks, tasks (or groups of tasks) associated with a project may be created, deleted, selected, deselected, modified, or otherwise customized in an operation 330.

Tasks may be customized in operation 320 by way of any suitable mechanism, such as a graphical user interface that may provide various forms, questionnaires, wizards, or other suitable guidance for customizing tasks. For example, in operation 320, a spreadsheet application enabled with a Visual Basic script or other suitable logic may present tasks to a user according to various groupings, types, or other criteria. Groupings or classifications of tasks may be according to service tiers (e.g., tasks may be included or excluded depending on an extent to which a project integrates a target system), task types (e.g., tasks may be classified as project management tasks, proof of concept tasks, high availability tasks, production tasks, or other criteria), or otherwise. Further, tasks may be itemized within or independently of tiers, classifications, groupings, or other criteria (e.g., a solution installation task group may include tasks for installing database software; installing database instances for portals or collectors; configuring databases for performance; installing and configuring data tools; or installing audit clients; among other solution installation tasks).

It will be apparent, therefore, that tasks may be organized, classified, or otherwise grouped in various ways, where each task may relate to one or more aspects, stages, services, or other components of a project plan, service proposal, or other use of human resources. As such, operation 330 may include dynamic customization of various tasks associated with a project plan or service proposal for any given use case. For example, based on project parameters, budgets, skill demands, or other criteria, tasks included in a given project plan may be varied to meet such needs. Operation 330 may further include validation logic or other suitable logic for ensuring that a project plan includes a suitable task list for the project. For example, the logic may be configured to identify dependencies or relationships among tasks, task groups, services, stages, agents, reports, rules, or other factors to ensure that a project plan framework includes suitable tasks for fulfilling the project.

In various implementations, however, users may elect to use a default set of tasks and/or task groupings, in which case no customization may occur. In such implementations, operation 330 may be bypassed, and processing may instead proceed directly to an operation 340 for allocating human resources to tasks included in the project plan, service proposal, or other task framework. When a user elects to customize tasks, however, the tasks may be customized in operation 330 prior to allocating human resources to the tasks in operation 340.

Each task included in a project plan may be associated with one or more default resource types (e.g., personnel having suitable qualifications to perform the task). For example, a project plan may include a group of tasks for developing a solution architecture overview document, which may further include a task for defining business requirements and goals. By default, the task for defining business requirements and goals may be allocated among various resource types, including principal architects, senior architects, associate architects, or other resource types. Each of these resource types may be expected to expend a certain amount of work effort (e.g., an estimated amount of time) during implementation of the task. Thus, based on a billing rate or other cost measure associated with the resource type, an itemized cost for any given task may be estimated, where such cost may further be itemized according to resource types assigned to the task.

It will be apparent that any given task may be allocated to various resource types, such that a project plan may include detailed information about tasks to be performed, resources to perform the tasks, skill levels, costs, or other measures associated with the resources, among various other things. Thus, in decisional operation 340, a user may indicate whether to customize the human resources associated with various project tasks, which may be used to modify costs, timelines, assigned skill sets, or other factors of a proposal or project plan. Alternatively, default resource types may be used, in which case operation 350 may be bypassed and the default resources may be allocated to the various tasks in an operation 360.

For example, in a high-impact project, an enterprise, client, or other entity may indicate a preference for more experienced human resources. As such, in operation 350, resources may be assigned to tasks in order to maximize skill levels (e.g., a senior project manager may perform all tasks, including those normally performed by associate project managers). Such an allocation may reduce an amount of work effort associated with the task (e.g., based on the higher skill level), while also impacting a cost associated with the task (e.g., based on a higher billing rate). By contrast, in a low-impact project, low-level task, or a task well-suited for training, an enterprise, client, or other entity may elect to minimize costs at a trade-off of assigning less skilled resources to the task. Such an allocation may increase an amount of work effort associated with the task, while reducing a cost associated with the task, among other effects. It will be apparent, however, that resource types may be customized or otherwise assigned to tasks for various reasons, and that such customizations or other assignments may have a variety of effects on a project, including but not limited to impacts on costs, work efforts, timelines, and skill levels, among others.

Furthermore, assignment of resource types to tasks may be constrained according to task type or other criteria. For example, to customize resource types as described above, a user may identify one or more tasks to be customized, and may further identify one or more resource types to associate with those tasks. As any given task may be associated with a different task type, however, the customized association of resource types and tasks may be validated (e.g., by determining that the resource types are eligible for association with the tasks). For example, a project plan may include task types such as architecture design, solution implementations, or testing, among various others, and each of the task types may be restricted to certain eligible resource types. For example, resource types eligible for association with architectural or other technical task types may be limited to the resource types having engineering or other suitable technical backgrounds (e.g., principal/senior/associate architects, engineers, consultants, etc.). In another example, eligibility for project management tasks may be limited to project manager resource types or other resource types having suitable qualifications. Accordingly, while resources may be dynamically assigned to tasks in operations 350/360, the assignment of resources may be validated to ensure that each task has been assigned to eligible resource type(s).

Subsequently, once all tasks and associated resource types have been determined for a given project plan or service proposals, an operation 370 may include assigning a risk factor to the project plan or service proposal. For example, an enterprise providing services for a high-profile client may determine that the project includes a certain amount of risk. In another example, low-profile or simple services may be associated with a comparatively lower risk. It will be apparent that risk may be assessed in various ways, and that the risk factor determined in operation 370 may be based on any appropriate criteria. The determined risk factor may then be applied against the project plan or service proposal (e.g., by marking up costs, work efforts, assigned resources, or other criteria). For example, a given task assigned to a principal architect resource type may be associated with a work effort and/or cost absent a determined risk factor, and the work effort and/or cost may be modified according to the risk factor using any appropriate technique (e.g., by increasing costs as a proportion of an increase in the risk factor). Other techniques for using the determined risk factor will be apparent.

Thereafter, having identified all tasks, resource types associated with the tasks, and the risk factor associated with the project plan or service proposal, the project plan may be generated in an operation 380 and/or the service proposal may be generated in an operation 390. For example, the project plan generated in operation 380 may set forth various phases for implementing the project, various tasks to occur during each of the phases, resources assigned to each of the tasks, and/or costs and work efforts associated with each of the resources, among other things. The service proposal generated in operation 390 may include similar information as may be included in the project plan. However, in various implementations, a project plan may be distinct from a service proposal, in that a project plan sets forth details for implementing a service to be provided, whereas a service proposal may set forth similar details in efforts of selling the service to a client (e.g., a service proposal may become a project plan when a client chooses to purchase the service).

It will be apparent, however, that any suitable application of human resource costs may make use of the techniques described herein. For example, the invention may be used to develop or devise plans and/or frameworks for internal projects (e.g., deploying new systems), training projects, third-party services, or any other application that may apply human resource costs. As such, the invention may have broad applicability to enable enterprises, clients, or other organizations to assess or otherwise plan the components of a project, including tasks, personnel, work efforts, costs, or other factors associated therewith.

Implementations of the invention may be made in hardware, firmware, software, or any combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, those skilled in the art will recognize that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it is understood that it is within the knowledge of one skilled in the art to effect such feature, structure, or characteristic in connection with other aspects or implementations whether or not explicitly described. Thus, various changes and modifications may be made, without departing from the scope and spirit of the invention. The specification and drawings are to be regarded as exemplary only, and the scope of the invention is to be determined solely by the appended claims.

What is claimed is:

1. A method for dynamically allocating human resources to a project plan, comprising:
retrieving data from a data repository, the retrieved data relating to at least one service provided by an organization;
generating a customizable project plan framework from the retrieved data, the generated framework including information relating to one or more tasks for implementing the service, wherein each of the tasks are associated with one or more resource types;
receiving a request to customize the generated framework, the received request defining a customization of one or more of the resource types associated with one or more of the tasks; and
customizing the generated framework based on the received request, the customized framework providing an estimate for the service based on the customization of the resource types.

2. The method of claim 1, the provided estimate including work efforts for the resource types to perform the tasks.

3. The method of claim 2, the provided estimate further including costs for the resource types to perform the tasks.

4. The method of claim 3, wherein the resource types are associated with respective billing rates, the work efforts estimate amounts of time for the resource types to perform the tasks, and the costs are a function of the billing rates and the amounts of time.

5. The method of claim 1, the received request further defining a customization of at least one of the tasks for implementing the service.

6. The method of claim 5, the customization of the tasks indicating one or more tasks to include in, or exclude from, the customized framework.

7. The method of claim 1, wherein the customization of the resource types identifies one or more tasks to customize, and further identifies one or more resource types to associate with the identified tasks.

8. The method of claim 7, further comprising validating that the identified resource types are eligible for association with the identified tasks.

9. The method of claim 1, the resource types including one or more of senior project managers, project managers, principal architects, senior architects, architects, principal consultants, senior consultants, consultants, or associate consultants.

10. A computer readable medium having computer executable instructions for dynamically allocating human resources to a project plan, the instructions operable when executed to:
retrieve data from a data repository, the retrieved data relating to at least one service provided by an organization;
generate a customizable project plan framework from the retrieved data, the generated framework including information relating to one or more tasks for implementing the service, wherein each of the tasks are associated with one or more resource types;
receive a request to customize the generated framework, the received request defining a customization of one or more of the resource types associated with one or more of the tasks; and
customize the generated framework based on the received request, the customized framework providing an estimate for the service based on the customization of the resource types.

11. The computer readable medium of claim 10, the provided estimate including work efforts for the resource types to perform the tasks.

12. The computer readable medium of claim 11, the provided estimate further including costs for the resource types to perform the tasks.

13. The computer readable medium of claim 12, wherein the resource types are associated with respective billing rates, the work efforts estimate amounts of time for the resource types to perform the tasks, and the costs are a function of the billing rates and the amounts of time.

14. The computer readable medium of claim 10, the received request further defining a customization of at least one of the tasks for implementing the service.

15. The computer readable medium of claim 14, the customization of the tasks indicating one or more tasks to include in, or exclude from, the customized framework.

16. The computer readable medium of claim 10, wherein the customization of the resource types identifies one or more tasks to customize, and further identifies one or more resource types to associate with the identified tasks.

17. The computer readable medium of claim 16, the instructions further operable to validate that the identified resource types are eligible for association with the identified tasks.

18. The computer readable medium of claim 10, the resource types including one or more of senior project managers, project managers, principal architects, senior architects, architects, principal consultants, senior consultants, consultants, or associate consultants.

19. A system for dynamically allocating human resources to a project plan, the system comprising at least one data repository that stores data relating to at least one service provided by an organization, and further comprising one or more processing devices collectively operable to:
retrieve the data from the data repository;
generate a customizable project plan framework from the retrieved data, the generated framework including information relating to one or more tasks for implementing the service, wherein each of the tasks are associated with one or more resource types;
receive a request to customize the generated framework, the received request defining a customization of one or more of the resource types associated with one or more of the tasks; and
customize the generated framework based on the received request, the customized framework providing an estimate for the service based on the customization of the resource types.

20. The system of claim 19, the provided estimate including work efforts for the resource types to perform the tasks.

21. The system of claim 20, the provided estimate further including costs for the resource types to perform the tasks.

22. The system of claim 21, wherein the resource types are associated with respective billing rates, the work efforts estimate amounts of time for the resource types to perform the tasks, and the costs are a function of the billing rates and the amounts of time.

23. The system of claim 19, the received request further defining a customization of at least one of the tasks for implementing the service.

24. The system of claim 23, the customization of the tasks indicating one or more tasks to include in, or exclude from, the customized framework.

25. The system of claim 19, wherein the customization of the resource types identifies one or more tasks to customize, and further identifies one or more resource types to associate with the identified tasks.

26. The system of claim 25, the processing devices further operable to validate that the identified resource types are eligible for association with the identified tasks.

27. The system of claim 19, the resource types including one or more of senior project managers, project managers, principal architects, senior architects, architects, principal consultants, senior consultants, consultants, or associate consultants.
